(19) United States
(12) Patent Application Publication
(10) Pub. No.: US 2004/0255741 A1
(43) Pub. Date: Dec. 23, 2004

(54) Metal die cutting apparatus and method of forming same

(76) Inventors: Guo Rui Deng, Dongguan (CN); Robert E. Workman, Spanish Fork, UT (US); Frank W. Compagni, Salt Lake City, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/601,828

(22) Filed: Jun. 23, 2003

(51) Int. Cl. B26D 1/00

(52) U.S. Cl. 83/13; 83/694

(57) ABSTRACT

A die cutting apparatus for forming die cuts from paper and other materials includes a metal base plate defining at least one channel therein for receiving at least one blade. The blade has a desired shape to provide a cutting edge with a predetermined contour to substantially match the contour of the at least one channel. The blade is welded to the base plate to secure it relative thereto and extends above the base plate to provide an exposed edge for cutting paper and the like into the predetermined contour. A covering is provided over at least a portion of the back surface of the base plate.

### BACKGROUND

1. Field of the Invention

The present invention relates to an apparatus for forming paper die cuts. More particularly, the present invention relates to a die cutting apparatus formed from metal for holding a die cutting blade having a desired pattern.

2. Description of the Prior Art

Die cuts are preformed pieces of paper or other cuttable material that are cut into a desired shape. For example, die cuts are often available in various shapes such as teddy bears, hearts, stars, etc. Multiple die cuts are usually packaged together for consumer purchase and may include die cuts formed from various colors of paper.

The die cuts are formed by pressing a blade, which has been formed into the desired exterior shape, against a sheet of paper or any other cuttable material to cut or punch out a section of the paper or other material corresponding to the shape of the blade. Typically, the blade is held in position by a block of wood.

Such die cutting blocks are typically comprised of a block of wood which has a desired pattern laser cut into the wood block. The laser cutting process forms a channel in the wood block for receiving a die cutting blade. The channel extends completely through the wood block but is discontinuous at certain points to keep the interior “cut out” portion of the wood block intact with the remainder of the block. A preformed blade, having a generally rectangular shape, bent to have the same pattern as the pattern cut in the wood block is then inserted into the channel formed therein.

Typically, the wood block is approximately ⅝ to ¾ inches in thickness and the blade is approximately 1 inch in width.

In order to ensure that the blade remains secured within the channel, the blade is essentially press fitted within the channel. Moreover, the desired shape is typically formed from several sections of blade, each of which must be individually and precisely forced into the channel. In order to insert the blade members, a skilled laborer must pound each of the individual blade members into the channel by hand. The blade is forced into the wood block until the back edge of the blade is substantially flush with or even extending slightly beyond the back side of the wood block, leaving a portion of the blade extending above the top surface of the wood block. With the exception of laser cutting the channel into the block, such die cutting blocks have been manufactured in this manner for decades with little, if any, improvement in the manufacturing or assembly processes.

This process of manufacturing such a die cutting instrument is time consuming and labor intensive. As such, the cost to manufacture each die cutting block is relatively high. The retail price of such die cutting blocks have an average retail price of approximately $120 dollars. The primary market for such die cutting blocks are commercial establishments that produce their own sets of die cuts or commercial establishments that allow their customers to use their die cutting machines to create die cuts for a fee. There has not been a die cutting system designed specifically for personal or home use.

One significant improvement to such conventional type die cutting device is described in U.S. patent application Ser. No. 09/896,667 (the '667 application). The '667 application discloses a die cutting block for forming die cuts from paper and other materials. The die cutting block includes a plastic base portion having a recess formed therein. The recess has a particular desired shape formed therein. An insert portion is utilized to wedge a blade between and tightly hold the blade between the base portion and the insert portion. The blade extends above the base portion and insert portion to provide an exposed edge for cutting paper and the like into a desired shape.

While the plastic block disclosed in the '667 application was a significant improvement over the prior art, it would be a further advantage to provide a die cutting block that is less expensive and easy to manufacture, easy to assemble, generally more durable and capable of being incorporated into and used with any similar die cutting apparatus. It would further be advantageous to provide such a die cutting block that can be manufactured at a price that makes it accessible to the average consumer for home use.

These and other advantages will become apparent from a reading of the following summary of the invention and description of the illustrated embodiments in accordance with the principles of the present invention.

### SUMMARY OF THE INVENTION

Accordingly, a die cutting block configured for cutting one or more sheets of paper is comprised of a base plate formed from low carbon steel plate. A steel rule blade is heat treated and toughened to a Rockwell C Hardness of approximately 40 following forming. The ends of the rule are aligned, clamped into position and welded together. The thickness of the base plate may vary depending upon the height of the steel rule. A design matching the outline of the steel rule design is cut into and through the base plate as with an electrical discharge machining (EDM) center. The width of the design outline is machined to substantially match the width of the steel rule, within certain tolerances.

The machining of the base plate results in at least two separate pieces. The first piece comprises the outside portion of the design outline and the second portion comprises the inside or “cut-out” portion of the design outline. The material removed during machining provides the space necessary to insert the blade therein so as to be ultimately held between the outside and inside portions.

The die cutting apparatus is formed by laying the outside portion of the base plate on a flat surface and positioning the inside portion within the base portion, also upon the flat surface. A preformed steel rule having a contour to substantially match the contour of the gap formed between the outside portion and the inside portion is pressed into the gap. The steel rule is pressed until it is approximately flush with the back surface of the base plate. This is accomplished by pressing the steel rule until it abuts against the flat surface.

To permanently secure the steel rule to the base plate, the steel rule blade is at least spot welded to both the outside and inside portions. This weld occurs along the back surface (i.e., the side of the base plate that rests upon the flat surface during assembly) of the base plate.

Any excess weld material may be ground away from the back surface to produce a relatively flush back surface. In order to cover the back surface that may contain weld marks, grinding marks and to further produce a relatively planar back surface, the base plate may then be plated, for example by electroplating, as with Cadmium to produce a polished, cosmetically finished outer surface and to further bond the blade to the base portion.

In order to reduce the cost of manufacturing that would be incurred by a plating process, a base plate housing or covering comprised of plastic is provided to cover the back and side surfaces of the base plate. Such a cover not only eliminates the need for any plating while still providing a cosmetically finished outer surface, but also provides a flat support surface for supporting the base plate. As such, any uneven surfaces in the back of the base plate resulting from the manufacturing process, that may otherwise cause uneven cutting by the die when used with a die press, are covered in a manner that allows relatively uniform force distribution over the entire back surface of the base plate.

The machining of the base plate may also produce slits or slots in the base plate having a particularly desired contour. Such slits or slots may not necessarily divide the base plate into separate pieces as previously described. A blade, however, can be inserted and secured relative to such slits or slots to provide one or more desired cutting edges having desired contours or shapes. In the case where an inner and outer base portion are formed, such slots or slits may be incorporated into either or both of the outer and/or inner base portions to produce an overall desired die cutting configuration.

### BRIEF DESCRIPTION OF THE DRAWINGS

The foregoing summary, as well as the following detailed description of the preferred embodiments is better understood when read in conjunction with the appended drawings. For the purpose of illustrating the invention, there is shown in the drawings embodiments that illustrate what is currently considered to be the best mode for carrying out the invention, it being understood, however, that the invention is not limited to the specific methods and instruments disclosed. In the drawings:

FIG. 1A is a back view of a first embodiment of a die cutting apparatus in accordance with the principles of the present invention;

FIG. 1B is a cross-sectional side view of the die cutting apparatus illustrated in FIG. 1A;

FIG. 2A is a cross-sectional side view of a second embodiment of a die cutting apparatus in accordance with the principles of the present invention;

FIG. 2B is a close-up detail of the die cutting apparatus illustrated in FIG. 2A;

FIG. 3A is a top view of a second embodiment of a preformed blade in accordance with the principles of the present invention;

FIG. 3B is a top view of a base plate for use with preformed blade illustrated in FIG. 3A in accordance with the principles of the present invention;

FIG. 3C is a cross-sectional side view of the blade illustrated in FIG. 3A and base plate illustrated in FIG. 3B with the base plate positioned on a support surface;

FIG. 3D is a cross-sectional side view of the blade and base plate illustrated in FIG. 3C in an assembled form in accordance with the principles of the present invention;

FIG. 4 is a schematic flow diagram illustrating a method of forming a die cutting apparatus in accordance with the principles of the present invention; and

FIG. 5 is a top view of a third embodiment of a die cutting apparatus in accordance with the principles of the present invention;

FIG. 6A is a top view of a fourth embodiment of a die cutting apparatus in accordance with the principles of the present invention; and

FIG. 6B is a cross-sectional side view of the die cutting apparatus illustrated in FIG. 6A.

### DETAILED DESCRIPTION OF THE ILLUSTRATED EMBODIMENTS

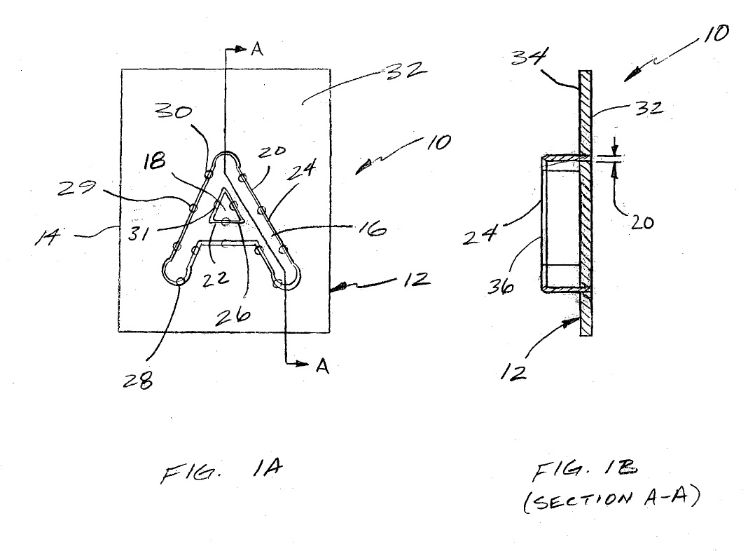

Referring to the drawings wherein like numerals indicate like elements throughout, there is shown in FIG. 1A a first embodiment of a die cutting apparatus, generally indicated at 10, in accordance with the principles of the present invention. The die cutting apparatus 10 is configured for cutting one or more sheets of paper or other desired material by firmly pressing the die cutting apparatus 10 against such material. The die cutting apparatus 10 is comprised of a metal base portion 12 having an outer portion 14 and a first inner portion 16 and a second inner portion 18. The metal base portion 12 is comprised of a metal plate, such as a low carbon (“soft”) steel, that is cut into the various outer and inner portions. The gap 20 between the outer portion 14 and the first inner portion 16 defines a first channel separating the outer portion 14 form the first inner portion 16. Likewise, the gap 22 between the first inner portion 16 and the second inner portion 18 defines a second channel separating the first inner portion 16 from the second inner portion 18.

The width of the channels 20 and 22 are sized to receive steel rule blades 24 and 26, respectively. Such steel rule may be heat treated and toughened to a Rockwell C hardness of 40 following forming. It is desirable to provide an interference fit between the blades 24 and 26 and the surfaces of the base portion 12 forming the channels 20 and 22 for assembly purposes. That is, during the assembly process, after the base portion 12 is cut, the blades 24 and 26 are pressed into the channels 20 and 22, respectively. The interference fit allows the assembly to hold itself while the base portion 12 is bonded to the blades 20 and 24, as by spot welds, such as spot welds 28, 29, 30 and 31 formed on the back side 32 of the base portion 12, as by TIG welding. The spot welds may subsequently be partially ground away to provide a relatively flat back surface 32 to the die cutting apparatus 10.

As better shown in FIG. 1B, the blade 24 is positioned within the channel 20 so as to be substantially flush with the back surface 32 of the base portion 12. The blade 24 extends above the top surface 34 of the base portion 12 so as to provide a cutting edge 36 along a surface thereof. The cutting edge 36 is substantially parallel to the back surface 32 of the base portion 12 so that when a force is applied in a direction normal to the back surface 32, the cutting edge 36 is substantially uniformly applied to a material to be cut along all portions of the cutting edge 24, thus providing a uniform cut of substantially equal depth along the entire length of the cutting edge 24.

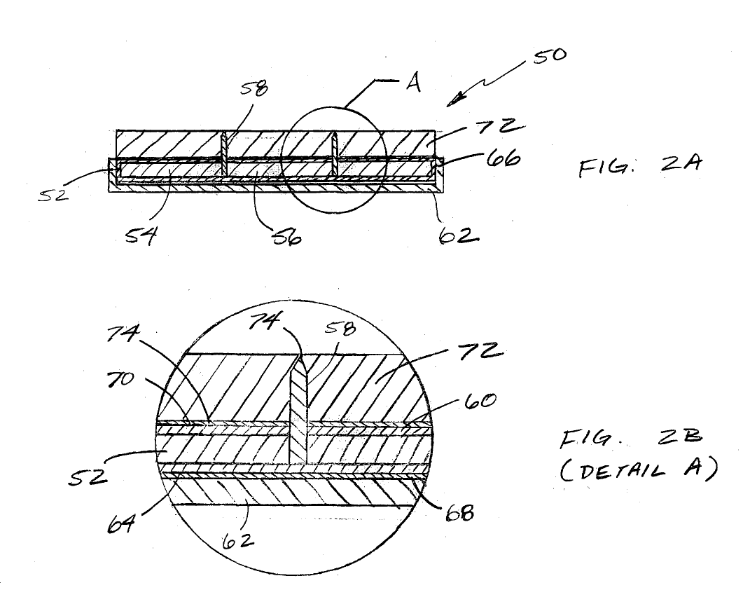

As illustrated in FIGS. 2A and 2B, a die cutting apparatus, generally indicated at 50, in accordance with the principles of the present invention is comprised of a base plate 52 having an outer portion 54 and an outer portion 56 separated by at least one blade 58. As better seen in FIG. 2B, the base plate 52 is provided with a layer 60 of plating that substantially surrounds the base plate 52 to provide a smooth outer surface. Such a layer 60 is more desirable when providing a die cutting apparatus, such as that shown in FIGS. 1A and 1B, to cover any spot welds and produce a more commercially attractive product. Such a layer 60, however, also helps to further secure the blade 58 to the base plate 52.

The die cutting apparatus 10 also includes a housing 62 for receiving and holding the base plate 52 therein. The housing 62 is essentially a plastic cover that extends along the bottom surface 64 of the base plate 52 and around the perimeter 66 on all sides thereof. The housing 62 is held to the base plate 52 with a layer 68 of adhesive.

Attached to the top surface 70 of the base plate 52 is a release pad 72 having a thickness approximately equal to the height of the blade 58 above the top surface 70 of the base plate 52. The release pad 72 is formed from a foam rubber material such as neoprene or a foam pad that is relatively easily compressible to expose the cutting edge 74 of the blade 58 when the die cutting apparatus 50 is being pressed against a material to be cut. That is, as the blade 58 is pressed against a material or stack of material, such as a stack of paper, the release pad 72 is compressed by the material as the blade 58 is thrust into the material for cutting. As the blade 58 is removed from engagement with the material, the release pad 72 expands back to its pre-cutting position (as shown in FIGS. 2A and 2B) to remove the material being cut from engagement with the blade 58. The release pad 72 is attached to the top surface 70 of the base plate 52 with a layer 74 of adhesive at least partially covering a portion of the top surface 70.

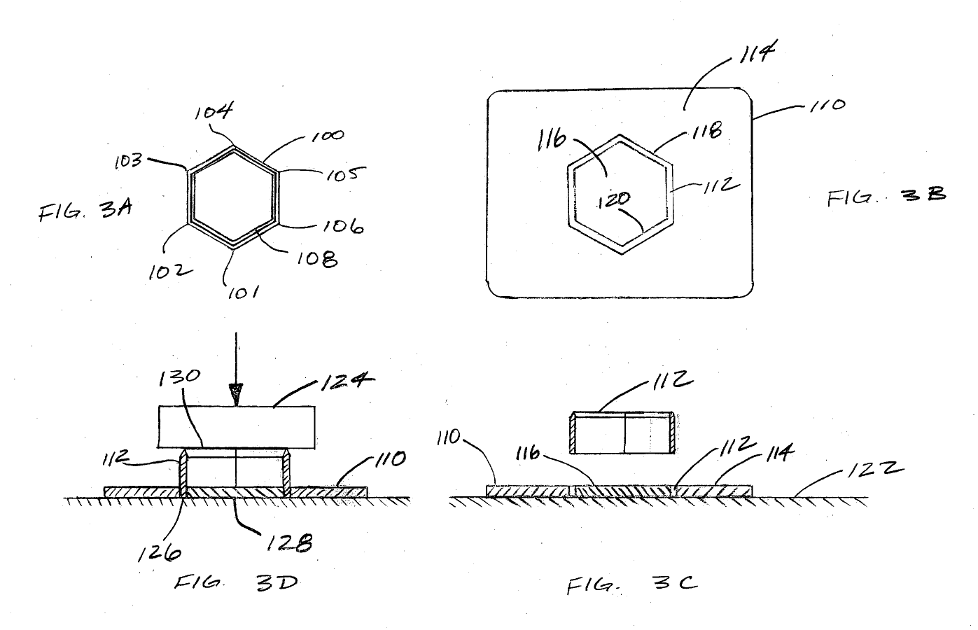

Referring now to FIGS. 3A, 3B, 3C and 3D, there is illustrated the various components of a die cutting apparatus in accordance with the principles of the present invention and how these components are assembled according to the present invention. As shown in FIG. 3A, a steel rule blade 100 has been bent into a preformed shape, in this example a hexagon. The blade 100 is formed by first providing an elongate strip of steel, forming a desired contour in the blade 100 by forming bends 101, 102, 103, 104, 105 and 106 and then attaching the two opposing ends of the strip with a transversely extending weld 108.

As shown in FIG. 3B, a base plate 110 has been cut, as by EDM machining a channel 112 into the base plate 110, to separate the base plate 110 into an outer portion 114 and an inner portion 116. As such, an inner surface 118 is formed on the outer portion 114 and an outer surface 120 is formed on the inner portion 116. Such inner and outer surfaces 118 and 120, respectively, define the contour of the channel 112 and are configured to substantially match the contour of the preformed blade 100, or vise versa. In addition, the width of the cut and the subsequent gap or channel 112 formed as a result of such cutting is such that the blade 100 can fit within the base plate 110 in the channel 112. It is desirable that the width of the channel 112 is such that an interference fit is formed between the blade 100 and the base plate 110 for assembly product strength purposes.

As illustrated in FIG. 3C, the outer and inner portions 114 and 116, respectively, are placed upon a flat support surface 122, with the inner portion 116 concentrically aligned within the outer portion 114 so as to provide a channel 112 of approximately equal width around the entire perimeter of the inside portion 116. The blade 112 is then positioned above the base portion 110.

As shown in FIG. 3D, the blade 112 is forced, as indicated by the arrow, into the base plate 110 as with a press 124 until the bottom surface or edge 126 of the blade 112 is substantially flush with the back surface 128 of the base plate 110. By doing so, it is at least reasonably ensured that the blade 112 is properly positioned relative to the base plate 110 such that the cutting edge 130 of the blade 112 is substantially parallel to the bottom surface 128 of the base plate 110. It should be noted that the thickness of the base plate 110 is such that the blade 112 will be provided proper lateral support during the manufacturing process as well as during use by an end user to prevent the blade from bending relative to the base plate. This is of particular relevance when utilizing blades of thinner cross-section or blades that are not necessarily adequately strengthened by the formations of bends therein.

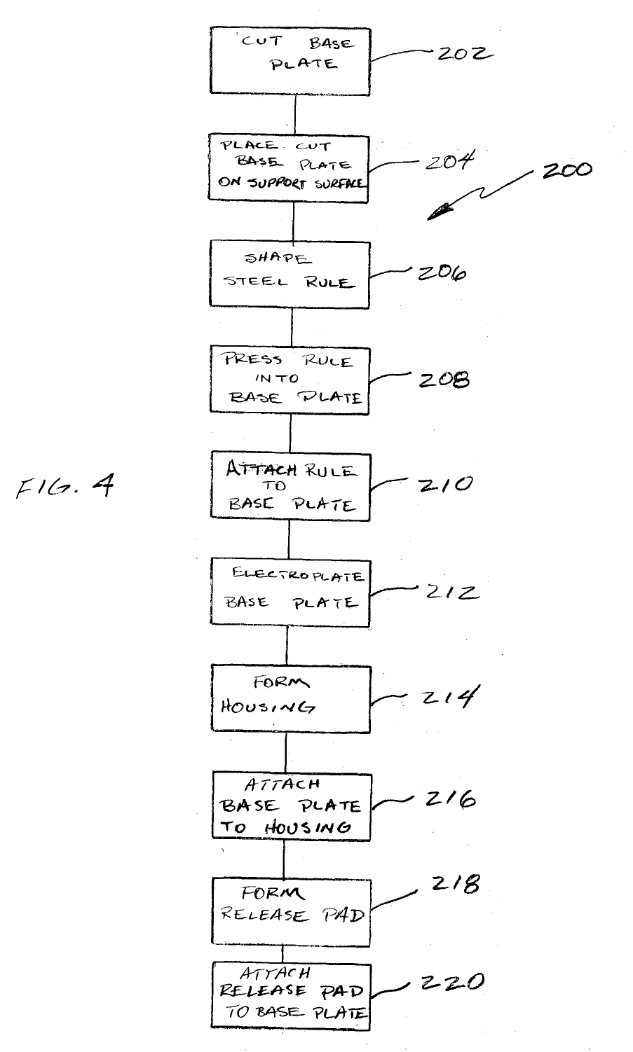

Referring now to FIG. 4, there is shown a schematic flow diagram of a method, generally indicated at 200, of manufacturing and assembling a die cutting apparatus in accordance with the principles of the present invention. It should be noted that while the steps shown in FIG. 4 are provided in a certain sequence, it will be apparent to those of skill in the art that the order of certain steps may be altered without effecting the formation of the desired end product. Thus, while the steps illustrate in FIG. 4 are provided in a particular order, it should be understood that the steps may be performed in other orders without departing from the spirit and scope of the invention and it is hereby submitted that the claims are intended to cover any such orders.

The method 200 includes the steps of cutting 202 the base plate to form one or more desired channels having a particular contour or shape for receiving one or more blades therein. Such cutting may be achieved by an EDM machining process or other cutting methods known in the art. The cut or machined base plate is then placed 204 upon a support surface for receiving the pre-shaped or preformed steel rule. One or more segments of steel rule blade are shaped 206 into a desired contour. Thus, more than one segment may be joined together as by welding to form a single shape (as may be necessary for complex configurations where bending will not necessarily achieve the desired shape) or more than one segment may be shaped to form various contours to provide various cutting edges in the finished product, though not necessarily forming part of the same contour or shape.

Each rule blade is then pressed 208 into the base plate until the non-cutting edge of the rule is substantially flush with the back side of the base plate. The rule is then attached 210 to the base plate as by spot welding or other methods of bonding or attachment known in the art. If desired, the base plate is plated 212 as by electroplating to provide a product having a desired finished appearance. For example, Cadmium plating may be provided. The plating is such that it is bonded to the base plate but not necessarily to sides of the blade. Of course, the plating type and color can be varied depending upon the desired finish. Such plating may cover any welds or discoloration in the base plate caused by the machining process. It should be noted, however, that when utilized with a covering or housing as previously described herein, such plating may not be necessary. In the case where such a housing is desired, a housing is formed 214 as by molding and attached 216 to the base plate. The housing may be molded from plastic or formed from other materials and/or processes known in the art.

Finally, a release pad is formed 218 and attached 220 to the top surface of the base plate. As previously discussed, the release pad provides protection from inadvertent engagement with the sharp edges of the blade while also providing a biasing means for removing material cut by the blade during use. The pad may be adhesively attached to the base plate or attached by other means known in the art.

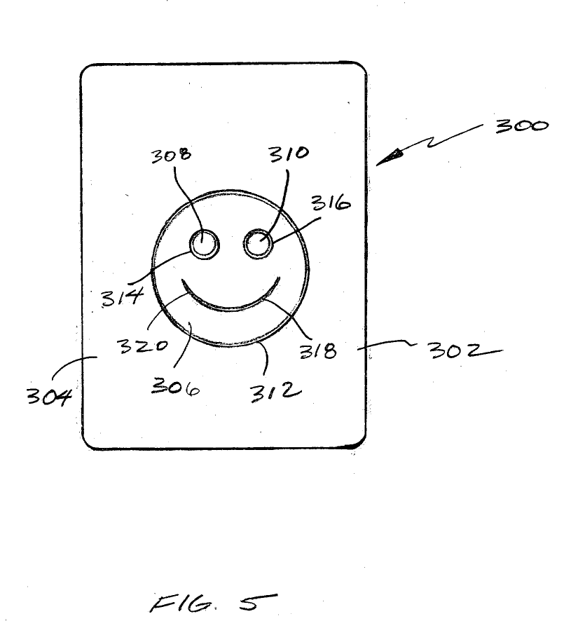

As further illustrated in FIG. 5, a die cutting apparatus, generally indicated at 300, in accordance with the principles of the present invention, may include blades having various contours and shapes, both enclosed shapes and open shapes into a single cutting apparatus 300. The base plate 302 has been divided into an outer portion 204, a first inner portion 306, a third inner portion 308 and a fourth inner portion 310. The first inner portion 306 lies within the outer portion 304 and the second and third inner portions 308 and 310 each lie within the first inner portion 306. Each of the portions 304, 306, 308 and 310 are separated by a respective blade 312, 314, and 316. A fourth blade 318, however, is provided in a elongate channel or slot 320 formed in the first inner portion 306, in this example to form the mouth of the smiley face. Such a blade 318 may be a straight edged blade or a perforation blade to form a perforation cut.

Thus, while forming the channels in the base plate 302 may form separate pieces, such as inner portions 306, 308 and 310, it is also part of the present invention to form channels 320 that form open sided contours as desired. The blade 318, however, can be inserted and attached to the base plate 302 as herein described.

While the blades forming the interior cuts described herein have been illustrated as being comprised of elongate, thin blade members, it is also contemplated that such blade members may be formed from punch type members such as those found on paper punches and the like. For example, if it is desired to cut eyes out of a sheet of material that is being die cut into the shape of a person or animal, elongate posts may be received within the insert holding one of the blades. The elongate posts may then be provided with sharpened edges for punching a hole in the material being cut. Furthermore, the posts may be held in place by providing a hole in the base plate. Such posts could then be attached, as by welding, to the base plate. As shown in FIG. 5, it is noted that the blades need not form a continuous, enclosed shape. The desired shape may be formed from a combination of continuous cuts, spaces and/or perforated cuts as my be desired.

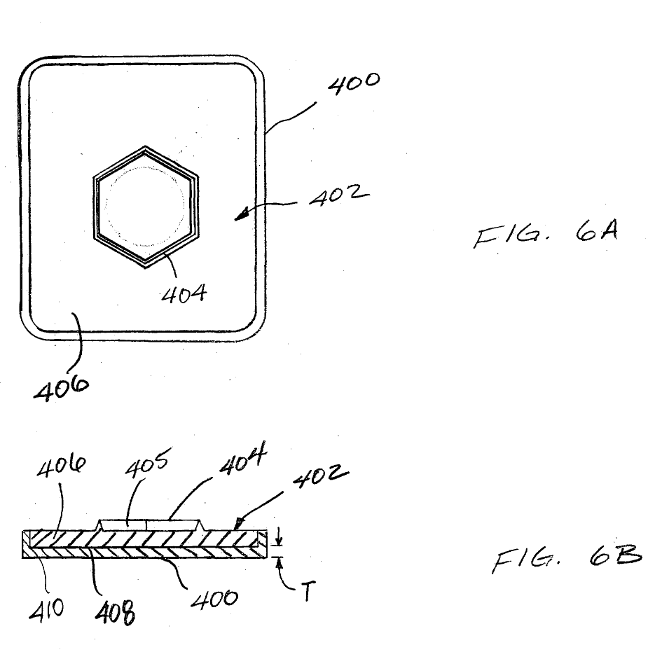

As shown in FIGS. 6A and 6B, a back cover or housing 400 similar to that illustrated in FIG. 2A, may be utilized with various other die cutting devices known in the art, such as a die cutting device 402 formed by a casting or etching process. With such a die 402, the blade 405 and its cutting edge 404 are integrally formed with the base plate 406 and the cutting edge 404 does not generally protrude above the top surface of the base plate 406 as much as the blades do in the other embodiments illustrated herein which have a steel rule blade/base plate configuration. The back cover 400 provides a cosmetic cover to the back side of the die cutting device 402 and also and is comprised of plastic that may be molded into the desired shape. Because the cover 400 is formed from a softer material than the metal die cutting device 402, any small protrusions in the back surface 408 of the die cutting device 402 can penetrate to some extent into the back cover 400 when the die cutting device 402 is pressed into a medium to be cut so that any pressing force is relatively uniformly applied over the exposed surface 410 of the cover 400 which translates into relatively uniform force being applied over the entire top surface or cutting edge 404 of the blade 405.

In addition, in order to be adaptable to different pressing machines used for die cutting purposes known in the art, the thickness T of the back cover 400 that supports and/or covers the back surface 408 of the base plate can be produced in any desired thickness to allow the die cutting device 402 to be used in virtually any pressing device known in the art. That is, many die cutting presses are configured to press a die cutting device of a particular thickness and are generally manufactured to be used with a particular die cutting device. By adjusting the thickness T of the back cover 400, the die cutting device 402 could be effectively adjusted in thickness to be acceptable and therefore usable with a particular die cutting machine known in the art. Thus, the housing 400 functions as an adapter for a die cutting device to allow such a die cutting device to be used in virtually any known die pressing machine.

While the methods and apparatus of the present invention have been described with reference to certain preferred embodiments to illustrate what is believed to be the best mode of the invention, it is contemplated that upon review of the present invention, those of skill in the art will appreciate that various modifications and combinations may be made to the present embodiments without departing from the spirit and scope of the invention as recited in the claims. The claims provided herein are intended to cover such modifications and combinations and all equivalents thereof. Reference herein to specific details of the illustrated embodiments is by way of example and not by way of limitation.

What is claimed is:

1. A die cutting apparatus, comprising:
at least one metal base portion defining at least one channel therein;
at least one blade positioned within said at least one channel and extending outwardly therefrom to expose at least one cutting edge along an edge of said at least one blade, said at least one blade bonded to said at least one metal base portion.

2. The die cutting apparatus of claim 1, wherein said metal base portion is comprised of at least two pieces, said at least one channel separating said at least two pieces, and said at least one blade interposed between said at least two pieces.

3. The die cutting apparatus of claim 1, wherein said at least one blade is substantially flush with a back surface of said at least one metal plate.

4. The die cutting apparatus of claim 1, further comprising at least one weld to bond said at least one blade to said at least one metal base portion.

5. The die cutting apparatus of claim 1, further comprising a layer of plating over at least a portion of said at least one metal base portion for further securing said at least one blade to said at least one base portion.

6. The die cutting apparatus of claim 1, wherein said at least one channel has a width to substantially match the width of said at least one blade to thereby provide an interference fit between said at least one blade and said at least one base portion.

7. The die cutting apparatus of claim 1, wherein said at least one base portion is comprised of a metal plate material.

8. The die cutting apparatus of claim 1, wherein said at least one cutting edge has a desired contour to substantially match a contour of said at least one channel.

9. The die cutting apparatus of claim 1, wherein a thickness of said at least one base portion is sufficient to provide adequate support for said at least one blade to prevent said at least one blade from bending in a transverse direction during use.

10. The die cutting apparatus of claim 1, wherein said at least one base portion comprises an outer portion and a separate inner portion, said inner portion having a first outer surface defining an outer contour to substantially match an inner contour defined by an inner surface of said outer portion, a gap between said inner portion and said outer portion defining said at least one channel.

11. The die cutting apparatus of claim 1, wherein at least one channel defines at least one elongate slot in said at least one base portion.

12. The die cutting apparatus of claim 11, further comprising at least one second blade positioned at least partially within said at least one elongate slot.

13. The die cutting apparatus of claim 11, wherein said at least one elongate slot is entirely interior to said at least one base portion.

14. The die cutting apparatus of claim 1, wherein said at least one base portion comprises at least one outer portion and first and second inner portions and said at least one blade comprises a first blade disposed within a first channel around said first inner portion and a second blade disposed within a second channel around said second inner portion.

15. The die cutting apparatus of claim 14, wherein said second inner portion is received within said first inner portion.

16. The die cutting apparatus of claim 1, further comprising a covering disposed over at least a portion of a back surface of said at least one metal base portion.

17. The die cutting apparatus of claim 16, wherein said covering is comprised of plastic.

18. The die cutting apparatus of claim 16, wherein said covering has a thickness for allowing use of said die cutting apparatus with an existing die cutting press.

19. The die cutting apparatus of claim 16, wherein said covering extends over said back surface of said at least one metal base portion and along at least a portion of a side of said at least one metal base portion.

20. A method of forming a die cutting apparatus, comprising:
providing a metal base plate having a top surface and a bottom surface;
cutting at least one channel into said metal base plate; inserting at least one blade into said at least one channel
to provide an exposed cutting edge; and attaching said at least one blade to said metal base plate.

21. The method of claim 20, wherein said inserting comprises placing said metal base plate on a surface and pressing said at least one blade into said at least one channel.

22. The method of claim 20, further comprising preforming a contour in said at least one blade to substantially match a contour of said at least one channel.

23. The method of claim 20, wherein said cutting comprising forming at least two separate pieces from said metal base plate, said at least one channel being defined between said at least two separate pieces.

24. The method of claim 20, wherein said cutting comprises EDM machining said metal base plate.

25. The method of claim 20, wherein said attaching comprises spot welding said at least one blade to said metal base plate.

26. The method of claim 20, further comprising plating said metal base plate.

27. The method of claim 20, further comprising providing a covering for covering at least a portion of a back side of said metal base plate.

28. The method of claim 27, wherein said providing a covering further comprises forming said covering from plastic.

29. The method of claim 27, further comprising attaching said metal base plate to said covering.

30. The method of claim 27, further comprising configuring said covering for allowing said die cutting apparatus to be used with an existing die cutting press.

31. The method of claim 20, further comprising forming a release pad and attaching said release pad to said base plate on a side of said base plate providing the exposed cutting edge.
